(19) United States
(12) Patent Application Publication
(10) Pub. No.: US 2025/0328761 A1
(43) Pub. Date: Oct. 23, 2025

(54) LIGHTWEIGHT ARTIFICIAL INTELLIGENCE COMPUTING DEVICE FOR VARIOUS APPLICATIONS, AND METHOD FOR OPERATING SAME

(71) Applicant: Korea Electronics Technology Institute, Seongnam-si (KR)

(72) Inventors: Byung Soo Kim, Yongin-si (KR); Hyeon Seong Kim, Seongnam-si (KR); Jea Hack Lee, Seongnam-si (KR); Young Ho Kim, Incheon (KR)

(21) Appl. No.: 19/253,375

(22) Filed: Jun. 27, 2025

Related U.S. Application Data
(63) Continuation of application No. PCT/KR2023/002718, filed on Feb. 27, 2023.

(30) Foreign Application Priority Data
Dec. 28, 2022 (KR) 10-2022-0187916

(51) Int. Cl. G06N 3/08; G06F 16/28

(52) U.S. Cl. CPC G06N 3/08; G06F 16/285

(57) ABSTRACT

Proposed is a lightweight AI computing device and operating method for various applications. The AI computing device may include an AI engine controller and a plurality of neuron cell modules. The AI engine controller may receive a data set including a feature vector and context information thereof, and transmit the feature vector to a neuron cell module that matches the context information of the feature vector. The neuron cell module may generate distance information between the center value vector of the neuron cell module and the feature vector, and when the distance information is less than or equal to the radius of the neuron cell module, transmit the distance information and class information of the neuron cell module to the AI engine controller. The AI engine controller may perform a learning or discrimination process on the basis of the distance information and the class information.

### CROSS REFERENCE TO RELATED APPLICATIONS

This is a continuation application of International Patent Application No. PCT/KR2023/002718 filed on Feb. 27, 2023, which claims priority to Korean patent application No. 10-2022-0187916 filed on Dec. 28, 2022, contents of each of which are incorporated herein by reference in their entireties.

### BACKGROUND

### Technical Field

The present disclosure relates to a lightweight artificial intelligence computing device and a method of operating the same.

### Description of Related Technology

For the processing and recognition of big data, deep learning artificial intelligence (AI) techniques based on backpropagation learning were primarily applied in the past, but recently, research and development on AI technology optimized for low-power, small embedded systems has been rapidly increasing.

### SUMMARY

One aspect is a lightweight artificial intelligence (AI) computing device and a method of operating the same, which perform AI training and recognition by allocating neurons for each context in order to process various applications.

Another aspect is a lightweight AI computing device and a method of operating the same, which designate neuron cells to perform training in real time according to the context of feature data, in order to train various types of datasets in real time.

Aspects of the present disclosure are not limited to those described herein. Other aspects that are not described may be obviously understood by those skilled in the art from the following specification.

Another aspect is a lightweight AI computing device for various applications that includes an AI engine controller; and a plurality of neuron cell modules with a designated context.

The AI engine controller may receive a training dataset including a first feature vector, context information of the first feature vector, and class information of the first feature vector and transmit the first feature vector to a neuron cell module matching the context information of the first feature vector among the plurality of neuron cell modules.

The neuron cell module matching the context information of the first feature vector may generate first distance information between a center value vector of the neuron cell module and the first feature vector and transmit the first distance information and class information of the neuron cell module to the artificial intelligence engine controller when the first distance information is less than or equal to a radius of the neuron cell module.

The AI engine controller may transmit a radius adjustment signal to the neuron cell module transmitting the first distance information when the class information of the neuron cell module transmitting the first distance information does not match the class information of the first feature vector.

The lightweight AI computing device may further include a minimum distance detection module.

The AI engine controller may receive a second feature vector and a recognition dataset including context information of the second feature vector and transmit the second feature vector to the neuron cell module matching the context information of the second feature vector among the plurality of neuron cell modules.

The neuron cell module matching the context information of the second feature vector may generate second distance information between the center value vector of the neuron cell module and the second feature vector and transmit the second distance information and the class information of the neuron cell module to the AI engine controller when the second distance information is less than or equal to the radius of the neuron cell module.

The minimum distance detection module may calculate a minimum value of the second distance information.

The AI engine controller may recognize the class information of the neuron cell module that transmits the distance information corresponding to the minimum value of the second distance information as the class information of the second feature vector.

The neuron cell module may include: a distance calculation unit that generates first distance information between the center value vector of the neuron cell module and the first feature vector; a comparator that determines whether the first distance information is less than or equal to the radius of the neuron cell module; and a neuron control unit that transmits the first distance information and the class information of the neuron cell module to the AI engine controller when the first distance information is less than or equal to the radius of the neuron cell module.

The neuron control unit may include a context register that stores context information of the neuron cell module.

The neuron control unit may include a class register that stores the class information of the neuron cell module.

According to an embodiment of the present disclosure, the neuron control unit may include a status register that stores training status information of the neuron cell module.

Another aspect is a method of operating a lightweight artificial intelligence (AI) computing device that includes: receiving, by an AI engine controller, a dataset including a feature vector, context information of the feature vector, and purpose information of the feature vector, and determining a neuron cell module matching the context information; transmitting the feature vector to the neuron cell module; and when the purpose information is “training,” training, by the AI engine controller, a radius of the neuron cell module based on distance information between the feature vector and a center value vector of the neuron cell module, class information of the neuron cell module, and class information of the feature vector included in the dataset.

The method of operating a lightweight AI computing device may further include, when the purpose information is “recognition,” recognizing, by the AI engine controller, the class information of the feature vector based on the distance information between the feature vector and the center value vector of the neuron cell module and the class information of the neuron cell module.

According to a lightweight artificial intelligence (AI) computing device and a method of operating the same according to an embodiment of the present disclosure, it is possible to train and recognize various applications on limited hardware resources.

In addition, according to a lightweight AI computing device and a method of operating the same according to an embodiment of the present disclosure, it is possible to eliminate the need to change an AI hardware device according to applications.

In addition, according to a lightweight AI computing device and a method of operating the same according to an embodiment of the present disclosure, it is possible to train a new dataset in real time according to a user environment and perform an operation of various user-centered applications.

Effects which can be achieved by the present disclosure are not limited to the above-described effects. That is, other objects that are not described may be obviously understood by those skilled in the art to which the present disclosure pertains from the following description.

### BRIEF DESCRIPTION OF THE DRAWINGS

FIG. 1 is a block diagram illustrating a configuration of a lightweight artificial intelligence (AI) computing device for various applications according to an embodiment of the present disclosure.

FIG. 2 is a block diagram illustrating a configuration of a neuron cell module of the lightweight AI computing device for various applications according to an embodiment of the present disclosure.

FIG. 3 is a diagram illustrating a neuron cell module designated for each context.

FIG. 4 is a diagram illustrating training status information of a neuron cell module designated for each context.

FIGS. 5A and 5B are flowcharts for describing a method of operating a lightweight AI computing device for various applications according to an embodiment of the present disclosure.

FIGS. 6A and 6B are diagrams illustrating results of performing training and recognition experiments for various applications using the lightweight AI computing device according to the present disclosure.

### DETAILED DESCRIPTION

Since the existing deep learning-based AI systems should have a deep structure, the existing deep learning-based AI systems require hundreds of billions to trillions of parameters (GPT-3 uses 175 billion parameters). In other words, the deep learning-based AI systems require enormous memory, which causes problems with hardware installation space and power. Therefore, in environments where a hardware area and available power are limited, it is difficult to design hardware for AI that may perform various user applications. Since enormous parameter memory is required, AI hardware is designed around specific datasets, and ultimately, the application of the existing hardware is limited.

In addition, since the AI hardware of which learning memory is difficult to install may only perform inference based on parameters trained on a server, there is a problem that flexible on-chip learning according to the user environment is not possible, and AI processing performance may decrease depending on the environment.

Advantages and features of the present disclosure and methods to achieve them will be elucidated from exemplary embodiments described below in detail with reference to the accompanying drawings. However, the present disclosure is not limited to exemplary embodiments to be described below, but may be implemented in various different forms, these embodiments will be provided only in order to make the present disclosure complete and allow those skilled in the art to completely recognize the scope of the present disclosure, and the present disclosure will be defined by the scope of the claims. Meanwhile, terms used in the present specification are for explaining exemplary embodiments rather than limiting the present disclosure. Unless explicitly described to the contrary, a singular form includes a plural form in the present specification. Components, steps, operations, and/or elements mentioned by terms “comprise” and/or “comprising” used in the present disclosure do not exclude the existence or addition of one or more other components, steps, operations, and/or elements.

Terms such as “first,” “second,” etc., used in the specification can be used to describe various components, but the components are not to be construed as being limited to the terms. These terms may be used to differentiate one component from other components. For example, a “first” component may be named a “second” component and a “second” component may also be similarly named a “first” component without departing from the scope of the present disclosure.

It is to be understood that when a component is referred to as being “connected to” or “coupled to” another component, it may be connected directly to or coupled directly to the other element or be connected to or coupled to the other element with other components intervening therebetween. On the other hand, it should be understood that when one component is referred to as being “connected directly to” or “coupled directly to” another component, it may be connected to or coupled to the other component without other components interposed therebetween. In addition, other expressions describing a relationship between components, that is, “between,” “directly between,” “neighboring,” “directly neighboring,” and the like, should be similarly interpreted.

In the present disclosure, “application” means a function performed by a lightweight artificial intelligence (AI) computing device according to the present disclosure for a specific purpose. For example, face recognition can be one “application” performed by the lightweight AI computing device according to the present disclosure.

In the present disclosure, “context” means a unit of work included in the application. For example, in the application called “face recognition,” when “face recognition” is performed through operations such as color feature extraction, texture feature extraction, shape feature extraction, and feature combination, each of the above-described operations is distinguished by context information.

In the present disclosure, a neuron cell module has its role distinguished according to context, and a plurality of neuron cell modules corresponding to one context may be combined to form a sub-network. Even if each neuron cell module included in the lightweight AI computing device according to the present disclosure uses the same training method, the neuron cell modules form a separate sub-network for each context. The neuron cell module performs training and recognition processes according to the context. One application may correspond to multiple contexts, and the sub-networks of multiple contexts corresponding to one application are combined to form a network that generates the necessary output of the corresponding application.

In describing the present disclosure, if it is determined that a detailed description of related known technologies may unnecessarily obscure the gist of the invention, a detailed description thereof will be omitted.

Hereinafter, embodiments of the present disclosure will be described in detail with reference to the accompanying drawings. The same means will be denoted by the same reference numerals throughout the accompanying drawings in order to facilitate the general understanding of the present disclosure in describing the present disclosure.

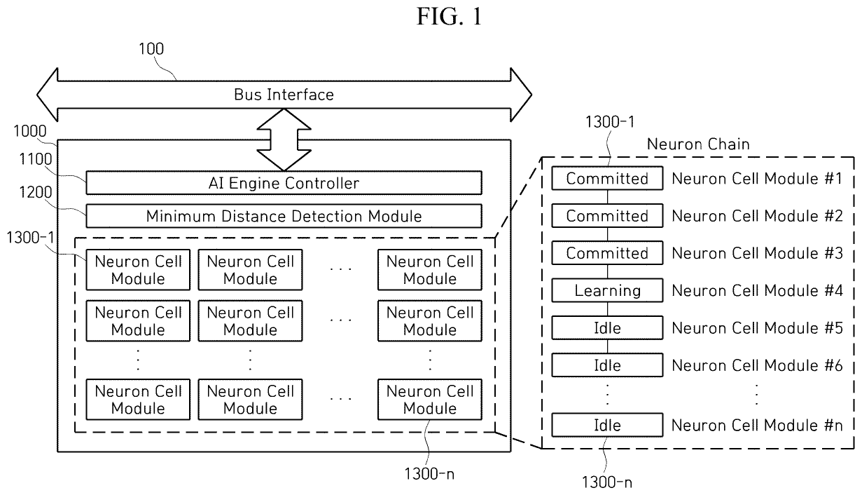

FIG. 1 is a block diagram illustrating a configuration of a lightweight AI computing device for various applications according to an embodiment of the present disclosure. FIG. 1 relates to hardware architecture of the AI computing device capable of processing various applications.

A lightweight AI computing device 1000 for various applications (hereinafter referred to as “lightweight AI computing device”) according to the embodiment of the present disclosure processes an RCE-NN algorithm operation. The lightweight AI computing device 1000 transmits and receives data packets to and from the outside through a bus interface 100, and includes an AI engine controller 1100, a minimum distance detection module 1200, and n neuron cell modules 1300-1 to 1300-n. Hereinafter, one of the plurality of neuron cell modules 1300-1 to 1300-n included in the lightweight AI computing device 1000 is called a “neuron cell module 1300.”

The lightweight AI computing device 1000 illustrated in FIG. 1 is according to the embodiment, and components of the lightweight AI computing device 1000 according to the present disclosure are not limited to the embodiment illustrated in FIG. 1, and some components may be added, changed, or omitted as needed.

In the present disclosure, “dataset” or “input dataset” means a set of data input to the AI engine controller 1100 through the bus interface 100. The dataset (input dataset) includes feature data, context information of the feature data, purpose information of the feature data, and a radius change range (or ratio). A training dataset further includes class information of the feature data. The recognition dataset does not include the class information of the feature data.

The AI engine controller 1100 trains a radius of each neuron cell module 1300 based on a minimum distance between a center value (called “center value vector” in the case of a vector) of each neuron cell module 1300 and the feature point with respect to the input dataset. The AI engine controller 1100 uses the same training method to train the radius of each neuron cell module 1300 but generates a separate sub-network for each context.

In the present disclosure, the radius is a numerical value indicating an influence field of the neuron cell module 1300 and is the same as an active influence field (AIF).

The AI engine controller 1100 receives the feature data, the context information of the feature data, and the purpose information (training or recognition) of the feature data through the bus interface 100. In the training process, the AI engine controller 1100 further receives the class information of the feature data through the bus interface 100.

In the present disclosure, “feature vector” means a case where the feature data has a vector form.

The AI engine controller 1100 transmits the feature vector to the neuron cell module 1300 through a multicast method. In this case, the AI engine controller 1100 may select the neuron cell module 1300 to transmit the feature vector based on the context information of the feature vector. That is, the AI engine controller 1100 may designate the context of the neuron cell module 1300. In this case, the AI engine controller 1100 may transmit the feature vector only to the neuron cell module 1300 that matches the context information of the feature vector when performing the subsequent training process and recognition process. The neuron cell module 1300 that receives the feature vector generates distance information between a unique center value vector of the neuron cell module 1300 and the feature vector based on the feature vector. The neuron cell module 1300 transmits the distance information and the class information of the neuron cell module 1300 to the AI engine controller 1100. The AI engine controller 1100 collects the distance information and the class information of the neuron cell module 1300 from each neuron cell module 1300 included in the lightweight AI computing device 1000. The AI engine controller 1100 transmits the distance information collected from each neuron cell module 1300 to the minimum distance detection module 1200.

The minimum distance detection module 1200 obtains a minimum value of the distance information of each neuron cell module 1300. That is, the minimum distance detection module 1200 generates a minimum distance value based on the distance information of each neuron cell module 1300.

The AI engine controller 1100 performs an AI determination operation based on the minimum distance value. In addition, the AI engine controller 1100 performs an AI training operation for the neuron cell module 1300 based on the minimum distance value, the class information of the feature vector, and the class information of the neuron cell module 1300.

According to an RCE-NN algorithm, the training of the neuron cell module 1300 is performed sequentially, and one neuron cell module 1300 is trained at a time. A neuron cell module 1300 that has not started training has status information of “idle,” a neuron cell module 1300 that is performing training has status information of “learning,” and a neuron cell module 1300 that has completed the training has status information of “committed.” That is, a neuron cell module 1300 that was initially in the “idle” state goes through the “learning” state and then switches to the “committed” state when the training is completed.

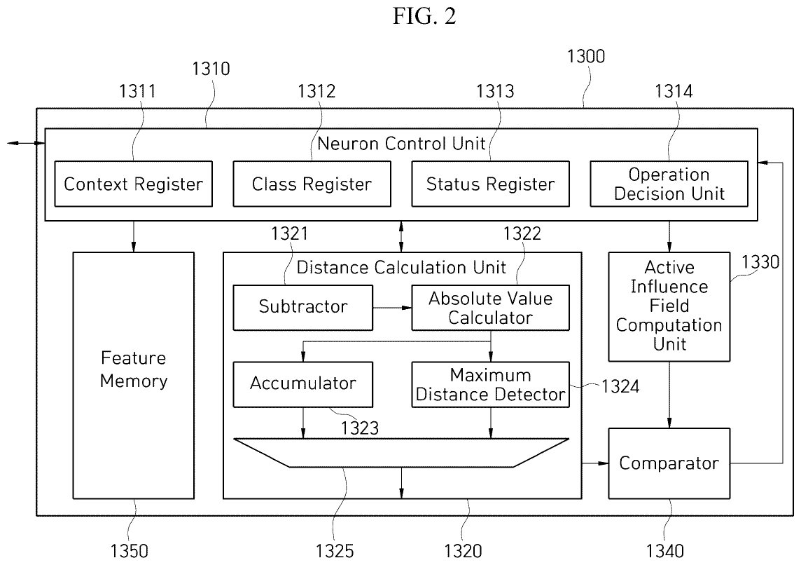

FIG. 2 is a block diagram illustrating a configuration of the neuron cell module of the lightweight AI computing device for various applications according to an embodiment of the present disclosure.

As illustrated in FIG. 2, the neuron cell module 1300 according to an embodiment of the present disclosure includes a neuron control unit (or a neuron controller) 1310, a distance calculation unit (or a distance calculator) 1320, an AIF computation unit (or an AIF computation processor), a comparator 1340, and a feature memory 1350. The neuron cell module 1300 illustrated in FIG. 2 is according to an embodiment and the components of the neuron cell module 1300 according to the present disclosure are not limited to the embodiment illustrated in FIG. 2, and some components may be added, changed, or omitted as needed.

The AI engine controller 1100 receives common constant setting data through the bus interface 100. The common constant setting data is data regarding a constant that is commonly applied to all the neuron cell modules 1300. For example, the common constant setting data includes a distance calculation standard (e.g., L1 Norm or L-infinity Norm), a purpose of the feature data (e.g., training, recognition), a value of a radius initially set by the neuron cell module 1300 (hereinafter, “initial radius”), etc.

Before the training of the neuron cell module 1300 is performed, the AI engine controller 1100 transmits the common constant setting data to an operation decision unit 1314 of the neuron cell module 1300, and the operation decision unit 1314 transmits the common constant setting data to each component of the neuron cell module 1300. For example, the operation decision unit 1314 transmits the distance calculation standard to the distance calculation unit 1320. When the distance calculation standard is set as “L1 Norm,” a multiplexer 1325 of the distance calculation unit 1320 transmits L1 Norm distance information generated by the accumulator 1323 to the comparator 1340 in the subsequent training process or recognition process. In addition, the operation decision unit 1314 sets the initial radius included in the common constant setting data as the radius of the corresponding neuron cell module 1300 at the time when the center value vector of the neuron cell module 1300 is determined.

In the training process, the neuron cell module 1300 receives the feature vector from the AI engine controller 1100 and calculates the distance between the center value vector stored in the feature memory 1350 and the feature vector. That is, the neuron cell module 1300 generates the distance information between the center value vector and the feature vector based on the center value vector and the feature vector. The neuron cell module 1300 compares the distance information with the radius of the neuron cell module 1300, and trains the radius based on whether the comparison result matches the class information of the feature vector.

In the recognition process, the neuron cell module 1300 receives the feature vector from the AI engine controller 1100 and calculates the distance between the center value vector stored in the feature memory 1350 and the feature vector. That is, the neuron cell module 1300 generates the distance information between the center value vector and the feature vector based on the center value vector and the feature vector. The neuron cell module 1300 compares the distance information and the radius of the neuron cell module 1300, and when the distance information is less than or equal to the radius, the neuron cell module 1300 is activated (fired), and transmits the class information of the neuron cell module 1300 to the AI engine controller 1100.

The neuron control unit 1310 controls each component of the neuron cell module 1300. The neuron control unit 1310 includes a context register 1311, a class register 1312, a status register 1313, and an operation decision unit 1314.

The context register 1311 is a component for designating a unique context so that each neuron cell module 1300 operates only for a specific context. The context register 1311 stores context information unique to the neuron cell module 1300. When the AI engine controller 1100 designates a context for the neuron cell module 1300, the AI engine controller 1100 transmits the context information to the corresponding neuron cell module 1300, and the neuron control unit 1310 stores the context information in the context register 1311. The neuron cell module 1300 calculates the distance information by distinguishing the application (dataset and feature point) currently being calculated based on the context information stored in the context register 1311. Each neuron cell module 1300 may operate only for one context, and the neuron cell modules 1300 trained for different contexts may operate only for applications related to those contexts.

The class register 1312 stores the class information unique to the neuron cell module 1300. Initially, the neuron cell module 1300 does not have a center value vector or the unique class information, and upon receiving the feature vector and the class information of the feature vector from the AI engine controller 1100, sets the feature vector as the center value vector and stores the feature vector in the feature memory 1350, and sets the class information of the feature vector as the class information of the neuron cell module 1300 and stores the class information in the class register 1312.

Meanwhile, the initial radius of the neuron cell module 1300 is set by the AI engine controller 1100 and stored in the feature memory 1350.

Each neuron cell module 1300 has a unique center value vector, radius, and class. The neuron cell module 1300 may exert the influence of the corresponding class on the feature value vector within the radius from the center expressed by the center value vector.

The status register 1313 stores the current training status information (hereinafter referred to as “status information”) of the neuron cell module 1300. That is, the status register 1313 indicates the training process of the neuron cell module 1300. Training of the neuron cell module 1300 becomes possible when the center value and the class are determined. For example, the training status information stored by the status register 1313 may be composed of three types: “idle,” “learning,” and “committed.” The status register 1313 has the status information “idle” when the training of the corresponding neuron cell module 1300 has not started, has the status information “learning” when the training is being performed, and has the status information “committed” when the training is completed.

In the training process of the neuron cell module 1300, the operation decision unit 1314 determines a command (radius adjustment signal) for changing the radius (i.e., AIF) of the current neuron based on information possessed by other components of the neuron control unit 1310, the comparison result of the comparator 1340, and the comparison result of the comparator of another neuron cell module.

The operation decision unit 1314 may receive the radius adjustment signal and the class information of the feature vector from the AI engine controller 1100. In addition, the operation decision unit 1314 may further receive the minimum distance value from the AI engine controller 1100.

When the operation decision unit 1314 receives the radius adjustment signal from the AI engine controller 1100, the operation decision unit 1314 compares the class information of the feature vector with the class information of the neuron cell module 1300, and when two pieces of class information do not match, the operation decision unit 1314 transmits the radius adjustment signal to the AIF computation unit 1330. When the operation decision unit 1314 further receives the minimum distance value, the operation decision unit 1314 may transmit, to the AIF computation unit 1330, the radius adjustment signal requesting that the radius of the neuron cell module 1300 be reduced to a lower limit.

The distance calculation unit 1320 generates the distance information between the feature vector and the center value vector of the neuron cell module 1300. The distance calculation unit 1320 generates one of the L1 Norm distance information and L-infinity Norm distance information between the feature vector and the center value vector of the neuron cell module 1300. The distance calculation unit 1320 includes a subtractor 1321, an absolute value calculator 1322, an accumulator 1323, a maximum distance detector 1324, and a multiplexer 1325.

The subtractor 1321 calculates a difference between the feature vector and the center value vector. The absolute value calculator 1322 obtains the absolute value of the difference between the feature vector and the center value vector. The accumulator 1323 adds up the absolute values calculated by the absolute value calculator 1322 according to the feature. That is, the accumulator 1323 generates the L1 Norm distance information between the feature vector and the center value vector based on the absolute values calculated by the absolute value calculator 1322. The maximum distance detector 1324 finds a maximum value among the absolute values calculated by the absolute value calculator 1322. That is, the maximum distance detector 1324 generates the L-infinity Norm distance information between the feature vector and the center value vector based on the absolute values calculated by the absolute value calculator 1322. The multiplexer 1325 transmits the result (L1 Norm distance information) of adding up the absolute values generated by the accumulator 1323 or the maximum value (L-infinity Norm distance information) of the absolute values obtained by the maximum distance detector 1324 to the comparator 1340 according to the setting.

For example, when the feature vector is (2,2) and the center value vector is (4,6), the subtractor 1321 obtains (−2, −4) that is the difference between the feature vector and the center value vector. The absolute value calculator 1322 obtains the absolute value of the difference, which is (2, 4). The accumulator 1323 obtains 6 by adding up the absolute values of the differences according to the feature (this is the L1 Norm distance information). The maximum distance detector 1324 calculates 4, which is the maximum value of the absolute values of the differences (this is the L-infinity Norm distance information). The multiplexer 1325 transmits either the L1 Norm distance information 6 or the L-infinity Norm distance information 4 to the comparator 1340 according to the setting.

The comparator 1340 compares the distance information generated by the distance calculation unit 1320 with the radius (AIF) of the neuron cell module 1300. Specifically, the comparator 1340 determines whether the distance information generated by the distance calculation unit 1320 is less than or equal to the radius of the neuron cell module 1300. In other words, the comparator 1340 determines whether the neuron cell module 1300 exerts the influence on the current feature point input.

When the distance information is greater than the radius of the neuron cell module 1300, the comparator 1340 determines that the corresponding neuron cell module 1300 has no influence on the current feature vector.

In addition, when the distance information is less than or equal to the radius of the neuron cell module 1300, the comparator 1340 determines that the corresponding neuron cell module 1300 may have influence (may exert influence) on the current feature vector. That is, each neuron cell module 1300 may exert influence equal to its own radius (AIF) at its own center value. In this case, when the class information of the feature vector is different from the class information of the neuron cell module 1300, the radius of the neuron cell module 1300 is reduced under the control of the AI engine controller 1100. That is, the AI engine controller 1100 performs training by reducing the influence of the neuron cell modules 1300 whose feature vector differs from the class information among the neuron cell modules 1300 that have influence on the feature vector.

The AIF computation unit 1330 changes the radius (AIF) of the neuron cell module 1300 according to the result of determining the operation decision unit 1314 of the neuron control unit 1310 in the training process. Upon receiving the radius adjustment signal, the AIF computation unit 1330 may update the radius of the neuron cell module 1300 by subtracting a preset radius change range (distance) from the radius of the neuron cell module 1300. As another example, the AIF computation unit 1330 may update the radius of the neuron cell module 1300 by multiplying the radius of the neuron cell module 1300 by a preset radius change ratio (e.g., 0.8). As another example, the AIF computation unit 1330 may reduce the radius of the neuron cell module 1300 to the lower limit according to the radius adjustment signal.

The feature memory 1350 stores data required for the computation of the neuron cell module 1300. For example, the feature memory 1350 stores the center value vector, the radius (AIF), and the feature vector of the neuron cell module 1300.

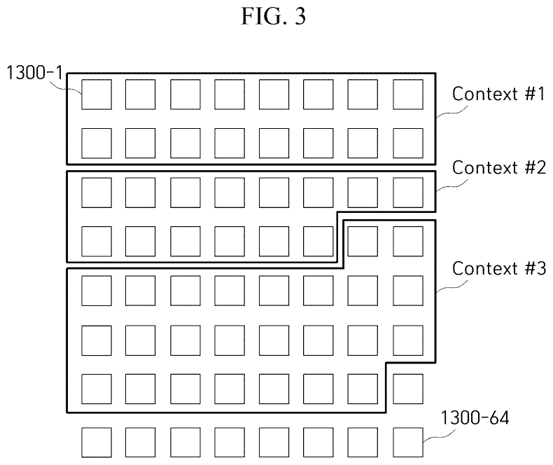

FIG. 3 is a diagram illustrating the neuron cell module designated for each context. As illustrated in FIG. 3, when there are 64 neuron cell modules 1300 in the lightweight AI computing device 1000, the plurality of neuron cell modules 1300 are designated for each context, and each neuron cell module 1300 may be trained and operated only for the application corresponding to the context. For example, when context #1 corresponds to application 1, 16 neuron cell modules 1300 are trained and operated for application 1. In addition, when context #2 corresponds to application 2, 14 neuron cell modules 1300 are trained and operated for application 2. When context #3 corresponds to application 3, 25 neuron cells are trained and operated for application 3.

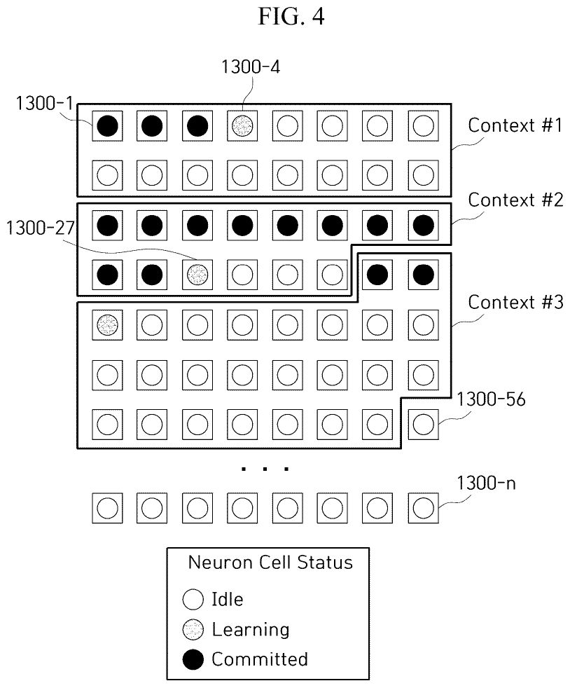

FIG. 4 is a diagram illustrating training status information of neuron cell modules for each context. The AI engine controller 1100 sequentially performs training on the neuron cell module 1300 according to the RCE-NN algorithm. The AI engine controller 1100 trains one neuron cell module 1300 at a time. The AI engine controller 1100 performs training for each context. Therefore, as illustrated in FIG. 4, when a dataset corresponding to context #1 is input, the AI engine controller 1100 performs training on a fourth neuron cell module 1300-4, and when a dataset corresponding to context #2 is input, the AI engine controller 1100 performs training on a 27th neuron cell module 1300-27. In addition, when a dataset according to a new context other than contexts #1 to #3 is input, the AI engine controller 1100 performs training on a 56th neuron cell module 1300-56.

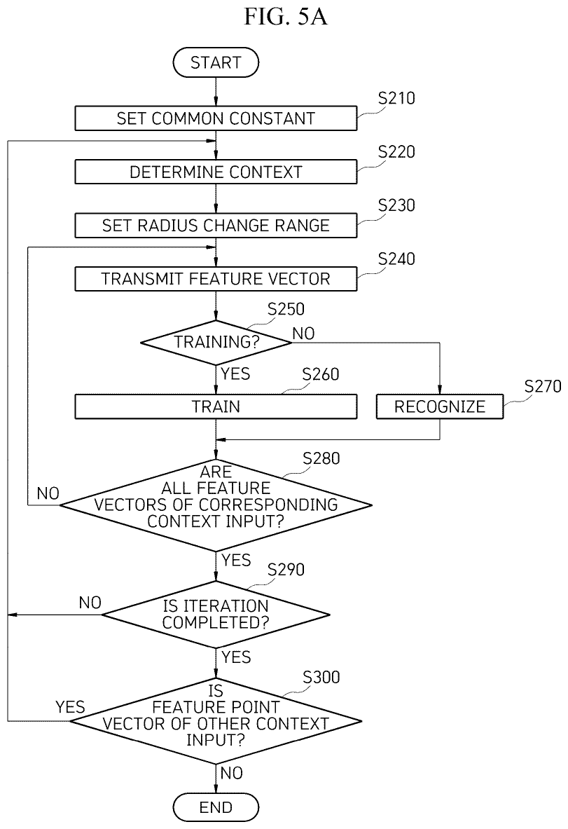

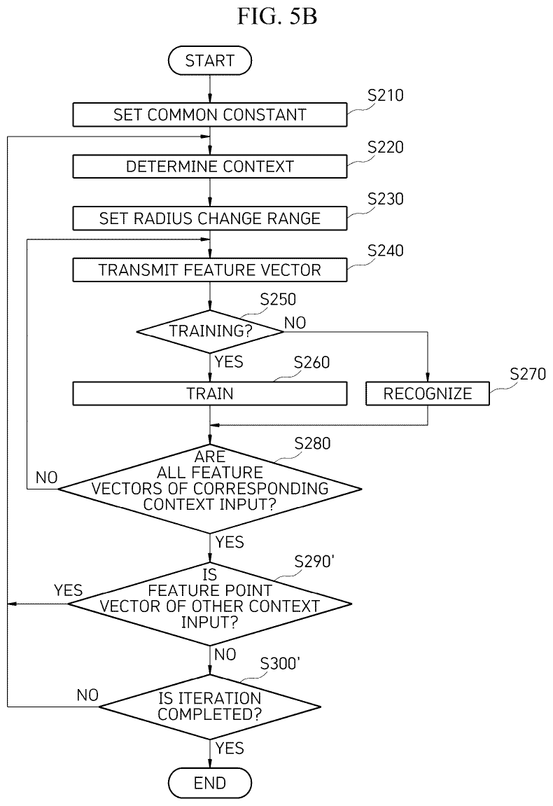

FIGS. 5A and 5B are flowcharts for describing a method of operating a lightweight AI computing device for various applications according to an embodiment of the present disclosure.

The flowcharts of FIGS. 5A and 5B illustrate an example of a method of operating training and recognition of a lightweight AI computing device 1000 for various applications (datasets).

The flowcharts in FIGS. 5A and 5B are generally similar but differ in their training approaches. In FIG. 5A, training is performed on a new application (dataset) after the training for one application is completed, while in FIG. 5B, training and determination operations are performed on one application, followed by training and determination operations on another application, and an interleaved training approach in which applications are alternated during training is performed.

The method of operating a lightweight AI computing device for various applications according to an embodiment of the present disclosure illustrated in FIG. 5A includes operations S210 to S300.

Operation S210 is a common constant setting operation. The AI engine controller 1100 receives the common constant setting data through the bus interface 100. The common constant setting data is data regarding a constant that is commonly applied to all the neuron cell modules 1300. For example, the common constant setting data includes the distance calculation standard (e.g., L1 Norm or L-infinity Norm), the purpose of the feature data (e.g., training, recognition), the initial radius of the neuron cell module 1300, etc.

The AI engine controller 1100 receives the common constant setting data through the bus interface 100. For example, the operation decision unit 1314 transmits the distance calculation standard to the distance calculation unit 1320. When the distance calculation standard is set as “L1 Norm,” the multiplexer 1325 of the distance calculation unit 1320 transmits the L1 Norm distance information generated by the accumulator 1323 to the comparator 1340 in the subsequent training process or recognition process.

In addition, the operation decision unit 1314 sets the initial radius included in the common constant setting data as the radius of the corresponding neuron cell module 1300 at the time when the center value vector of the neuron cell module 1300 is determined.

In addition, the AI engine controller 1100 may determine whether to train the neuron cell module 1300 or perform the recognition operation based on the feature data input later, according to the purpose information (e.g., training, recognition) of the feature data included in the common constant setting data.

Operation S220 is a context determination operation. The AI engine controller 1100 receives the dataset through the bus interface 100. The dataset (input dataset) includes the feature data, the context information of the feature data, the purpose information of the feature data, and the radius change range (or ratio), and in the case of the training dataset, unlike the recognition dataset, the dataset further includes the class information of the feature data. The AI engine controller 1100 determines the context of the currently input feature data based on the context information of the feature data. The AI engine controller 1100 determines the neuron cell module that matches the context information of the feature data. In this operation, the AI engine controller 1100 may determine whether to perform training or whether to perform recognition based on the feature data, according to the purpose information (e.g., “training,” “recognition”) of the feature data.

Operation S230 is the radius change range setting operation. The AI engine controller 1100 transmits the radius change range (or ratio) information included in the dataset to the operation decision unit 1314 of each neuron cell module 1300. The radius change range (or ratio) is the maximum change range (distance) or the maximum change ratio of the radius (AIF) in the training process of the neuron cell module 1300. The radius change range may include information on either the upper limit or the lower limit of the radius or a combination thereof. The radius change ratio may be a radius reduction ratio (e.g., 0.8). The operation decision unit 1314 transmits the radius change range or the radius change ratio to the AIF computation unit 1330. The AIF computation unit 1330 applies the received radius change range or radius change ratio when the radius (AIF) is changed in the training process later.

Operation S240 is a feature vector transmission operation. The feature data included in the received data set may be the feature vector. The AI engine controller 1100 determines the input of the feature vector included in the data set and transmits the feature vector to each neuron cell module 1300 in a multicast manner. In this case, the AI engine controller 1100 transmits the feature vector only to the neuron cell module 1300 that has a context that matches the context information of the feature vector.

Operation S250 is an operation of determining the purpose of the feature vector. The AI engine controller 1100 determines the purpose of the feature vector based on the purpose information of the feature vector. That is, the AI engine controller 1100 determines whether the input feature vector is input for training or for recognition. The AI engine controller 1100 performs operation S260 when the purpose information of the feature vector is “training,” and performs operation S270 when the purpose information of the feature vector is “recognition.”

Operation S260 is a training operation. The neuron cell module 1300 performs training under the control of the AI engine controller 1100. In this case, the radius (AIF) of the neuron cell module 1300 may be changed.

The neuron control unit 1310 transmits the feature vector to the distance calculation unit 1320. The distance calculation unit 1320 generates the distance information between the feature vector and the center point vector of the neuron cell module 1300 (L1 Norm or L-infinity Norm).

The comparator 1340 compares the distance information generated by the distance calculation unit 1320 with the radius (AIF) of the neuron cell module 1300. When the distance information is greater than the radius of the neuron cell module 1300, the comparator 1340 determines that the corresponding neuron cell module 1300 has no influence on the current feature vector. Therefore, the neuron cell module 1300 is not activated for the corresponding feature vector. In addition, when the distance information is less than or equal to the radius of the neuron cell module 1300, the comparator 1340 determines that the corresponding neuron cell module 1300 may have influence (may exert influence) on the current feature vector. In this case, the comparator 1340 transmits the determination result to the operation decision unit 1314, and the operation decision unit 1314 transmits the distance information and the class information of the neuron cell module 1300 to the AI engine controller 1100.

The AI engine controller 1100 transmits the distance information transmitted from each neuron cell module 1300 to the minimum distance detection module 1200. The minimum distance detection module 1200 generates the minimum distance value based on the distance information of each neuron cell module 1300.

The AI engine controller 1100 compares the class information of the feature vector with the class information of the neuron cell module 1300 that has transmitted the distance information, and transmits the radius adjustment signal and the class information of the feature vector to the neuron cell module 1300 whose class information does not match. In this case, the AI engine controller 1100 may further transmit the minimum distance value to the neuron cell module 1300.

When the operation decision unit 1314 of the neuron cell module 1300 receives the radius adjustment signal, the operation decision unit 1314 compares the class information of the feature vector with the class information of the neuron cell module 1300, and when two pieces of class information do not match, the operation decision unit 1314 transmits the radius adjustment signal to the AIF computation unit 1330. When the operation decision unit 1314 further receives the minimum distance value, the operation decision unit 1314 may transmit, to the AIF computation unit 1330, the radius adjustment signal requesting that the radius of the neuron cell module 1300 be reduced to the lower limit.

Upon receiving the radius adjustment signal, the AIF computation unit 1330 may update the radius of the neuron cell module 1300 by subtracting the preset radius change range (distance) from the radius of the neuron cell module 1300. As another example, the AIF computation unit 1330 may update the radius of the neuron cell module 1300 by multiplying the radius of the neuron cell module 1300 by the preset radius change ratio (e.g., 0.8). As another example, the AIF computation unit 1330 may reduce the radius of the neuron cell module 1300 to the lower limit according to the radius adjustment signal.

Operation S270 is the recognition operation. The neuron cell module 1300 performs the recognition operation under the control of the AI engine controller 1100. In this case, the radius (AIF) of the neuron cell module 1300 is not changed.

The neuron control unit 1310 transmits the feature vector to the distance calculation unit 1320. The distance calculation unit 1320 generates the distance information between the feature vector and the center point vector of the neuron cell module 1300 (L1 Norm or L-infinity Norm).

The comparator 1340 compares the distance information generated by the distance calculation unit 1320 with the radius (AIF) of the neuron cell module 1300. When the distance information is greater than the radius of the neuron cell module 1300, the comparator 1340 determines that the corresponding neuron cell module 1300 has no influence on the current feature vector. Therefore, the neuron cell module 1300 is not activated for the corresponding feature vector. In addition, when the distance information is less than or equal to the radius of the neuron cell module 1300, the comparator 1340 determines that the corresponding neuron cell module 1300 may have influence (may exert influence) on the current feature vector. In this case, the comparator 1340 transmits the determination result to the operation decision unit 1314, and the operation decision unit 1314 transmits the distance information and the class information of the neuron cell module 1300 to the AI engine controller 1100.

The AI engine controller 1100 transmits the distance information transmitted from each neuron cell module 1300 to the minimum distance detection module 1200. The minimum distance detection module 1200 generates the minimum distance value based on the distance information of each neuron cell module 1300. When there is no neuron cell module 1300 that has transmitted the distance information, the AI engine controller 1100 recognizes the corresponding feature vector as “unknown.”

The AI engine controller 1100 determines the class of the neuron cell module 1300 having the minimum distance value as the class to which the corresponding feature vector belongs. When there are a plurality of neuron cell modules 1300 that have calculated the minimum distance value, the AI engine controller 1100 determines the corresponding feature vector as “uncertainty.”

Operation S280 is an operation for determining whether all the feature vectors of the corresponding context have been input. When all samples of the feature data (feature vector) for a specific context have been input, the AI engine controller 1100 performs operation S290, and otherwise proceeds with operation S240.

Operation S290 is an operation of determining whether iteration is completed. The AI engine controller 1100 determines whether there is an additional iteration input for a sample collection of the feature data (feature vector) for a specific context. The AI engine controller 1100 performs operation S300 when the iteration is completed and performs operation S220 when the iteration is not completed.

Operation S300 is an operation of determining whether there is an input of a feature vector of another context. When there is an input of the feature data (feature vector) corresponding to a different context from the current context, the AI engine controller 1100 performs operation S220, and otherwise ends the process.

Referring to FIG. 5A, the method of operating a lightweight AI computing device for various applications according to an embodiment of the present disclosure illustrated in FIG. 5A includes operations S210 to S300. The method of operating a lightweight AI computing device for various applications illustrated in FIG. 5A is according to an embodiment, and the operations of the method of operating a lightweight AI computing device for various applications according to the present disclosure are not limited to the embodiment illustrated in FIG. 5A, and some components may be added, changed, or omitted as needed.

The method of operating a lightweight AI computing device for various applications according to an embodiment of the present disclosure illustrated in FIG. 5B includes operations S210 to S280 and operations S290′ and S300′. Operation S290′ is identical to operation S300 of FIG. 5A, and operation S300′ is identical to operation S290 of FIG. 5B, and therefore description thereof is omitted. In short, FIG. 5B is a version of FIG. 5A in which the order of operations S290 and S300 is reversed.

The method of operating a lightweight AI computing device illustrated in FIG. 5B differs from that of FIG. 5A in that the training and recognition operations are performed on one application, followed by training and recognition operations on another application, and an interleaved training approach in which applications are alternated during training is performed.

The above-described method of operating a lightweight AI computing device for various applications has been described with reference to the flowchart illustrated in the drawings. For simplicity, the method has been illustrated and described as a series of blocks, but the invention is not limited to the order of the blocks, and some blocks may occur with other blocks in a different order or at the same time as illustrated and described in the present specification. Also, various other branches, flow paths, and orders of blocks that achieve the same or a similar result may be implemented. In addition, all the illustrated blocks are not necessarily required for implementation of the methods described in the present specification.

Meanwhile, in the description with reference to FIGS. 5A to 5B, each operation may be further divided into additional operations or combined into fewer operations according to an implementation example of the present disclosure. In addition, some operations may be omitted if necessary, and an order between the operations may be changed. In addition, the content of FIGS. 1 to 4 may be applied to the content of FIGS. 5A to 5B even if other content is omitted. In addition, the content of FIGS. 5A to 5B may be applied to the content of FIGS. 1 to 4.

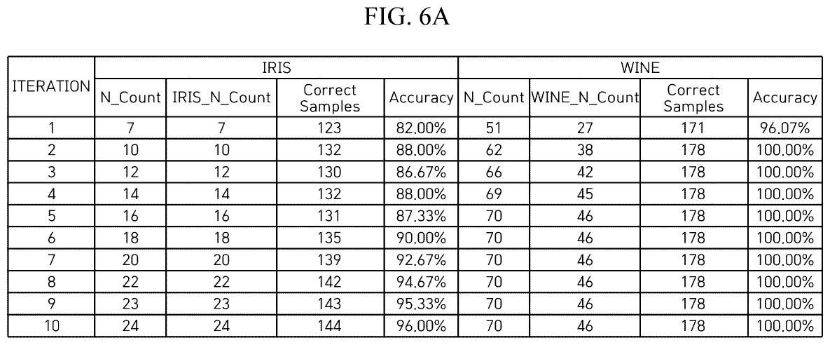

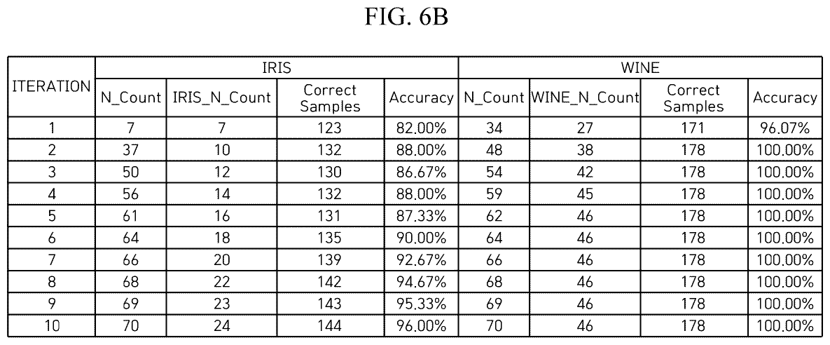

FIGS. 6A and 6B are diagrams illustrating the results of performing training and recognition experiments for various applications using the lightweight AI computing device according to the present disclosure.

The experimental results of FIG. 6A are the training and recognition results according to the operation method of FIG. 5A, and the experimental results of FIG. 6B are the training and recognition results according to the operation method of FIG. 5B.

“ITERATION” means iteration, and “N_Count” means the number of neuron cell modules used in the training process. In other words, “N_Count” means the number of neuron cell modules in the committed state. The total number of samples of “IRIS” is 150, and the total number of samples of “WINE” is 178. “Accuracy” means accuracy (%) and indicates the ratio of the number of correctly recognized samples (correct samples) to the total number of samples.

Comparing FIGS. 6A and 6B, the two operation methods show the same experimental results (accuracy). Therefore, when the data included in the dataset is distinguished by the context during the real-time training and recognition, it may be seen that training and determination can be determined easily and the same result value may be obtained regardless of the order of each dataset.

Although exemplary embodiments of the present disclosure have been disclosed above, it may be understood by those skilled in the art that the present disclosure may be variously modified and changed without departing from the scope and spirit of the present disclosure described in the following claims.

What is claimed is:

1. A lightweight artificial intelligence (AI) computing device for various applications, the device comprising:
an AI engine controller; and
a plurality of neuron cell modules with a designated context,
the AI engine controller configured to:
receive a training dataset including a first feature vector, context information of the first feature vector, and class information of the first feature vector, and
transmit the first feature vector to a neuron cell module matching the context information of the first feature vector among the plurality of neuron cell modules,
the neuron cell module matching the context information of the first feature vector configured to:
generate first distance information between a center value vector of the neuron cell module and the first feature vector, and
transmit the first distance information and class information of the neuron cell module to the AI engine controller in response to the first distance information being less than or equal to a radius of the neuron cell module, the AI engine controller further configured to:
transmit a radius adjustment signal to the neuron cell module transmitting the first distance information in response to the class information of the neuron cell module transmitting the first distance information not matching the class information of the first feature vector.

2. The lightweight AI computing device of claim 1, further comprising a minimum distance detection module,
the AI engine controller configured to:
receive a second feature vector and a recognition dataset including context information of the second feature vector, and
transmit the second feature vector to the neuron cell module matching the context information of the second feature vector among the plurality of neuron cell modules,
the neuron cell module matching the context information of the second feature vector configured to:
generate second distance information between the center value vector of the neuron cell module and the second feature vector, and
transmit the second distance information and the class information of the neuron cell module to the AI engine controller in response to the second distance information being less than or equal to the radius of the neuron cell module,
the minimum distance detection module configured to calculate a minimum value of the second distance information, and
the AI engine controller further configured to recognize the class information of the neuron cell module that transmits the distance information corresponding to the minimum value of the second distance information as the class information of the second feature vector.

3. The lightweight AI computing device of claim 1, wherein the neuron cell module includes:
a distance calculator configured to generate first distance information between the center value vector of the neuron cell module and the first feature vector;
a comparator configured to determine whether the first distance information is less than or equal to the radius of the neuron cell module; and
a neuron controller configured to transmit the first distance information and the class information of the neuron cell module to the AI engine controller in response to the first distance information being less than or equal to the radius of the neuron cell module.

4. The lightweight AI computing device of claim 3, wherein the neuron controller includes a context register configured to store context information of the neuron cell module.

5. The lightweight AI computing device of claim 3, wherein the neuron controller includes a class register configured to store the class information of the neuron cell module.

6. The lightweight AI computing device of claim 3, wherein the neuron controller includes a status register configured to store training status information of the neuron cell module.

7. A method of operating a lightweight artificial intelligence (AI) computing device, comprising:
receiving, by an AI engine controller, a dataset including a feature vector, context information of the feature vector, and purpose information of the feature vector, and determining a neuron cell module matching the context information;
transmitting the feature vector to the neuron cell module; and
in response to the purpose information being “training,” training, by the AI engine controller, a radius of the neuron cell module based on distance information between the feature vector and a center value vector of the neuron cell module, class information of the neuron cell module, and class information of the feature vector included in the dataset.

8. The method of claim 7, further comprising, in response to the purpose information being “recognition,” recognizing, by the AI engine controller, the class information of the feature vector based on the distance information between the feature vector and the center value vector of the neuron cell module and the class information of the neuron cell module.
